(19) United States
(12) Patent Application Publication
(10) Pub. No.: US 2006/0182847 A1
(43) Pub. Date: Aug. 17, 2006

(54) Method for manufacturing bonbons with a stalk or the like and mould applied thereby

(76) Inventor: Wim Richard Geltmeyer, Moerbeke-Waas (BE)

Correspondence Address: BACON & THOMAS, PLLC, 625 SLATERS LANE, FOURTH FLOOR, ALEXANDRIA, VA, 22314, US

(21) Appl. No.: 11/354,149

(22) Filed: Feb. 15, 2006

(30) Foreign Application Priority Data
Feb. 16, 2005 (BE) 2005/0082

(51) Int. Cl. B65D 85/00; A23G 3/00

(52) U.S. Cl. 426/91

(57) ABSTRACT

Method for manufacturing bonbons with a stalk or the like, characterized in that use is made of a mould (1) with at least one deepened part (3) whose wall is provided with an opening (4) and which consists in providing a stalk (5) or the like through the opening (4), such that another far end (6) thereof will extend in the deepened part (3), after which a measured amount of melted chocolate (7) or the like is poured in this deepened part (3) and is cooled, such that, after the chocolate (7) or the like has set, a bonbon (11) is formed in which the above-mentioned stalk (5) or the like is cast in the chocolate (7) with the above-mentioned far end (6).

### BACKGROUND OF THE INVENTION

1. Field of the Invention

The present invention concerns a method for manufacturing bonbons with a stalk or the like.

In particular, the invention concerns a method for manufacturing bonbons, such as cherry liqueur chocolates, pralines, Easter eggs or the like, whereby these bonbons are provided with the stalk of a piece of fruit, a stick, a cord or the like.

2. Discussion of the Related Art

A method for manufacturing such bonbons is already known, which mainly consists of briefly immersing in chocolate for example a cherry or another piece of fruit that was previously macerated in liqueur, after which the chocolate which sticks to this cherry is made to set, such that a praline is formed.

Next, a stalk or the like is immersed in chocolate with one far end, after which it is held against the bonbon with this far end, as a result of which, due to the setting of the chocolate, the stalk will adhere to the praline.

A disadvantage of this known traditional method is that it is very time-consuming and expensive.

### SUMMARY OF THE INVENTION

The present invention aims to remedy the above-mentioned and other disadvantages.

To this end, the present invention concerns a method for manufacturing bonbons with a stalk or the like, whereby use is made of a mould with at least one deepened part whose wall is provided with an opening and which consists in providing a stalk or the like through the opening, such that one far end thereof still extends in the deepened part, after which a measured amount of molten chocolate or the like is poured in this deepened part and is cooled, such that, after the chocolate or the like has set, a bonbon is formed in which the above-mentioned stalk or the like is cast in the chocolate with its above-mentioned far end.

Such a method is advantageous in that it allows for an automation, as a result of which it can be applied in a mechanized manner on a large scale and as a result of which the production times and cost price decrease considerably, whereas a product quality comparable to that of the traditional method is obtained.

The present invention also concerns a mould which can be applied in a method according to the invention, which mould is provided with at least one deepened part whose wall is provided with an opening.

### BRIEF DESCRIPTION OF THE DRAWINGS

In order to better explain the characteristics of the present invention, the following method according to the invention for manufacturing bonbons with a stalk or the like is given as an example only without being limitative in any way, with reference to the accompanying drawings, in which:

FIGS. 1 to 5 represent a method according to the invention;

FIG. 6 represents a bonbon which is made according to the method of the invention;

FIG. 7 represents a variant of a bonbon according to FIG. 6;

FIG. 8 represents a variant of a mould according to FIG. 1.

### DESCRIPTION OF THE PREFERED EMBODIMENT

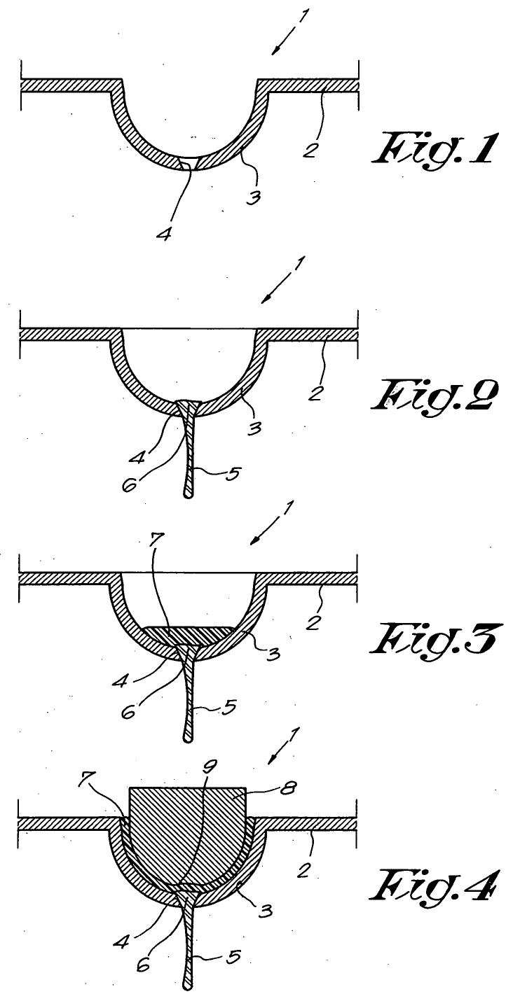

FIG. 1 is a partial section of a mould 1 which can be applied in a method according to the invention, which mould 1 in this case consists of a base plate 2 in which has been provided a deepened part 3.

In the wall of the deepened part 3 is provided an opening 4, conical in this case, which extends entirely through this bottom wall and which narrows towards the outside of the mould 1.

The method according to the invention mainly consists in that a stalk 5 or the like is provided through the above-mentioned opening 4 in the above-mentioned mould 1, such that this opening 4 is sealed.

As is represented in FIG. 2, the above-mentioned stalk 5 can be provided with a thickening on far end 6 which is preferably larger than the above-mentioned opening 4 or which is complementary to it, and which is made practically conical in this case, such that a good sealing of the opening 4 is obtained.

The above-mentioned stalk 5 can for example be made of paper, plastic or other materials which are allowed in the food sector.

Next, as is represented in FIG. 3, in the mould 1, is poured a measured amount of chocolate 7 or the like.

In a following step, as is represented in FIG. 4, a cooled die 8 is pressed in the mould 1, such that the chocolate 1 or the like is spread against the wall of the deepened part 3 with a more or less even thickness.

The above-mentioned die 8 is preferably provided with a recess 9 which, when the die 8 is in use, is situated opposite the above-mentioned opening 4 in the mould 1, such that when the chocolate 7 is pressed on with the die 8, a layer of chocolate is formed on the thickened far end 6, whose thickness corresponds to the thickness of the chocolate layer between the die 8 and the wall of the deepened part 3.

Since the above-mentioned die 8 is cooled, the chocolate 7 will set in such a manner that a little tub is formed in which the above-mentioned stalk 5 is held, as it is cast in the chocolate with its far end 6.

Next, a filling is provided in the above-mentioned tub, such as a créme, a syrup, a piece of fruit, caramel or the like.

In the case of FIG. 5, for example, a cherry 10 is provided in the above-mentioned tub, after which the rest of the tub is filled with for example chocolate.

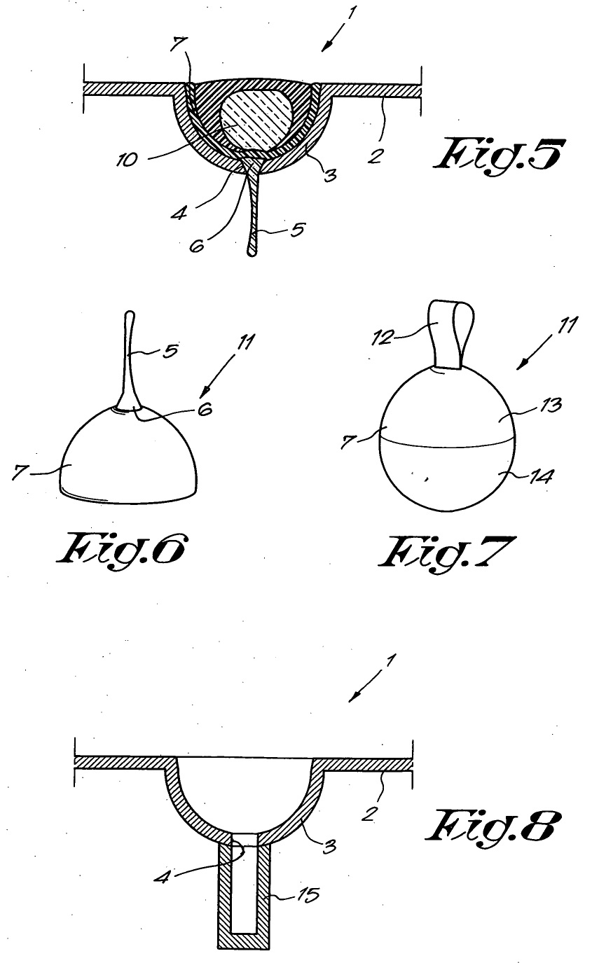

Thus, after everything has set, a bonbon 11 is formed which is provided with a stalk, as is represented in FIG. 6 and 15, which can then be removed from the mould 1.

FIG. 7 represents a variant of a bonbon 11 which is obtained by means of a method according to the invention.

In this case, the bonbon 11 is made in the shape of a chocolate egg, which is provided with an appendage in the shape of a little ribbon 12, both far ends of which are held in the chocolate.

To manufacture such a bonbon 11, a half egg 13 is made according to the method as described above, and a second half egg 14 is formed in a known mould without opening, after which these two halves are melted together so as to form an egg.

FIG. 8 represents a variant of a mould 1 which can be applied in a method according to the invention, whereby the above-mentioned opening 4 in the deepened part 3 is covered on one side by means of a holder 15 for the stalk 5 or the like.

The method for manufacturing bonbons by means of such a mould is analogous to the one described above.

However, such a variant is advantageous in that the chocolate which runs through the opening 4, along the stalk 5 or the like, ends up in the holder 15 and is not lost.

Another advantage thereof is that, by means of the above-mentioned holder 15, the stalk 5 is positioned in the right place.

Naturally, all sorts of bonbons can be made with a method according to the invention, and it is not restricted to the use of chocolate, but it also allows to manufacture bonbons made of other materials, such a for example sugar.

It is also clear that the above-mentioned stalk 5 or the like, which is provided on a bonbon 11 which is obtained with a method according to the invention, can be made in all sorts of different shapes, such as for example in the shape of a little cord, liquorice or the like.

The present invention is by no means limited to the embodiment given as an example and represented in the accompanying drawings; on the contrary, such a method according to the invention for manufacturing bonbons with a stalk or the like and a mould applied thereby, can be made in all sorts of shapes and dimensions while still remaining within the scope of the invention.

1. A method for manufacturing bonbons with a stalk or the like, comprising: providing a mould with at least one deepened part whose wall is provided with an opening; and providing a stalk or the like through the opening, such that one far end thereof still extends in the deepened part, after which a measured amount of molten chocolate or the like is poured in this deepened part and is cooled, such that, after the chocolate or the like has set, a bonbon is formed in which the stalk or the like is cast in the chocolate with the far end.

2. The method according to claim 1, wherein the stalk or the like seals the opening.

3. The method according to claim 1, wherein the far end of the stalk is provided with a thickening which is larger than the opening.

4. The method according to claim 1, wherein the chocolate or the like, which is provided in the mould, is spread against the wall of the deepened part by means of a die so as to form a tub.

5. The method according to claim 4, wherein the die is a cooled die.

6. The method according to claim 4, wherein the die is provided with a recess which, when the die is in use, is situated opposite the opening in the mould.

7. The method according of claim 4, wherein in the tub is provided a filling in the form of a créme, a syrup, a piece of fruit, caramel or the like.

8. The method according to claim 1, wherein the bonbon is provided with a little ribbon, a little cord or the like.

9. A mould which can be applied in a method according to claim 1, wherein the mould is provided with at least one deepened part whose wall is provided with an opening.

10. The mould according to claim 9, wherein the mould is provided with a continuous conical opening which narrows towards the outside of the mould.

11. The mould according to claim 9, wherein the opening is covered on one side in the deepened part by means of a holder for the stalk or the like.
